(19) United States
(12) Patent Application Publication
(10) Pub. No.: US 2017/0171497 A1
(43) Pub. Date: Jun. 15, 2017

(54) Method and Device for Automatically Adjusting Volume

(71) Applicants: Le Holdings (Beijing) Co., Ltd., Beijing (CN); Le Shi Zhi Xin Electronic Technology (Tianjin) Limited, Beijing (CN)

(72) Inventors: Hua Kang, Beijing (CN); Ning Cheng, Beijing (CN); Xun Xu, Beijing (CN); Yingjie Li, Beijing (CN)

(73) Assignees: Le Holdings (Beijing) Co., Ltd., Beijing (CN); Le Shi Zhi Xin Electronic Technology (Tianjin) Limited, Beijing (CN)

(21) Appl. No.: 15/246,060

(22) Filed: Aug. 24, 2016

Related U.S. Application Data
(63) Continuation-in-part of application No. PCT/CN2016/088456, filed on Jul. 4, 2016.

(30) Foreign Application Priority Data
Dec. 15, 2015 (CN) 201510946678.3

(51) Int. Cl. H04N 5/60; H04N 5/45; H04N 7/14

(52) U.S. Cl. CPC H04N 5/607; H04N 7/142; H04N 5/45; H04N 2007/145

(57) ABSTRACT

Disclosed are a method and a device for automatically adjusting a volume under a picture by picture circumstance, and a smart device. The method comprises: monitoring whether a sound source used for video playing and a sound source used for video calls of the smart device operate simultaneously, wherein the sound source used for video calls comprises an input sound source and/or an output sound source; adjusting a video playing volume and/or video call volume according to a monitoring result. The method for automatically adjusting the volume under a picture by picture circumstance of the present disclosure is capable of automatically adjusting the video playing volume and the video call volume according to actual situations without manual intervention; therefore, the experience of users is enhanced.

### CROSS-REFERENCE TO RELATED APPLICATIONS

This application is a continuation-in-part of International Application No. PCT/CN2016/088456, filed on Jul. 4, 2016, which is based upon and claims priority to Chinese Patent Application No. 201510946678.3, filed on Dec. 15, 2015, the entire contents of which are incorporated herein by reference.

### TECHNICAL FIELD

The disclosure relates to the technical field of smart devices, and in particular, to a method and a device for automatically adjusting a volume under a picture by picture circumstance, and a smart device.

### BACKGROUND

The so-called “picture in picture” or “picture by picture” function of a smart device refers to enabling answering of a video call while watching a television program (or a video).

A specific scenario is shown as follows: when a user watches a television program (or a video), in case of an incoming video call, the user selects a picture-in-picture mode of the video call, and then a video call window will be scaled down and displayed on the bottom left of a screen; the background window is still showing television pictures that the user is watching, and the television program is still playing.

In this process, in order to make the voice in the video call clear, the volume of the television program needs to be turned down, and the volume of the voice call needs to be turned up. When the call is finished or suspended, the volume of the television needs to be recovered.

In the process of implementing the present disclosure, the inventor has found out that at least the following problem exits in the prior art:

With respect to the user's experience, a user needs to frequently turn up or down the volume of a television program during a video call. For example, when the user needs to hear clearly the voice of the opposite party, the volume of the television program needs to be turned down (it is also possible to turn down the volume of the call while turning down the volume of the television program). During the video call, when both parties stop talking temporarily, the volume of the television program also needs to be turned up to achieve the effect of watching the program normally. Such a repeated volume adjusting process is quite inconvenient, and the user's experience is bad.

### SUMMARY

The object of the present disclosure is to provide a method and a device for automatically adjusting a volume under a picture by picture circumstance, and a smart device, thereby achieving a function of automatically adjusting the volume of the smart device under a picture by picture circumstance and enhancing the user's experience.

In order to achieve the above object, an embodiment of the present disclosure provides a method for automatically adjusting a volume under a picture by picture circumstance. The method includes:

monitoring whether a sound source used for video playing and a sound source used for video calls of a smart device operate simultaneously, wherein the sound source used for video calls includes an input sound source and/or an output sound source;

adjusting a video playing volume and/or video call volume according to a monitoring result.

According to a second aspect, the present invention also provides an electronic device, including a memory and at least one central processing unit, where the memory is connected to the at least on central processing unit by using a bus, the memory is configured to store a computer instruction, and when the device runs, the at least on central processing units executes the device to execute the following operations: monitor whether a sound source used for video playing and a sound source used for video calls of a smart device operate simultaneously, wherein the sound source used for video calls comprises an input sound source and/or an output sound source; adjust a video playing volume and/or video call volume according to a monitoring result.

According to a third aspect, the present invention provides a non-volatile computer readable storage medium, where the non-volatile computer readable storage medium stores a computer instruction, and a computer executes the computer instruction to execute the following operations: monitor whether a sound source used for video playing and a sound source used for video calls of a smart device operate simultaneously, wherein the sound source used for video calls comprises an input sound source and/or an output sound source; adjust a video playing volume and/or video call volume according to a monitoring result.

According to the interference-preventing communication method and device, the co-channel interference problem is effective avoided by means of Wifi channel avoidance. Therefore, the signal quality of wireless transmission is improved, and the packet loss/packet error rate is reduced, thereby enhancing experience with such functions as speech recognition rate and air mouse of the 2.4G remote controller.

### BRIEF DESCRIPTION OF THE DRAWINGS

In order to more clearly illustrate the technical solutions in the embodiments of the present disclosure, accompanying drawings needing to be used in description of the embodiments or the prior art will be introduced below briefly. Apparently, the accompanying drawings in the description below are some embodiments of the present disclosure, and for those of ordinary skill in the art, other drawings may also be obtained according to the accompanying drawings without creative work.

FIG. 1 is a flow diagram of a method for automatically adjusting a volume under a picture by picture circumstance provided by a first embodiment of the present disclosure.

FIG. 2 is a flow diagram of a method for automatically adjusting a volume under a picture by picture circumstance provided by a fifth embodiment of the present disclosure.

FIG. 3 is a flow diagram of a method for automatically adjusting a volume under a picture by picture circumstance provided by a sixth embodiment of the present disclosure.

FIG. 4 is a structural schematic diagram of a device for automatically adjusting a volume under a picture by picture circumstance provided by a seventh embodiment of the present disclosure.

FIG. 5 is a structural schematic diagram of a device for automatically adjusting a volume under a picture by picture circumstance provided by an eleventh embodiment of the present disclosure.

FIG. 6 is a structural schematic diagram of a device for automatically adjusting a volume under a picture by picture circumstance provided by a twelfth embodiment of the present disclosure.

FIG. 7 is a structural block diagram of a smart device provided by a fourteenth embodiment of the present disclosure.

### DESCRIPTION OF THE EMBODIMENTS

In order to make the object, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure, but not all embodiments. On the basis of the embodiments in the present disclosure, all the other embodiments obtained by those of ordinary skill in the art without creative work should fall into the scope of protection of the present disclosure.

### First Embodiment

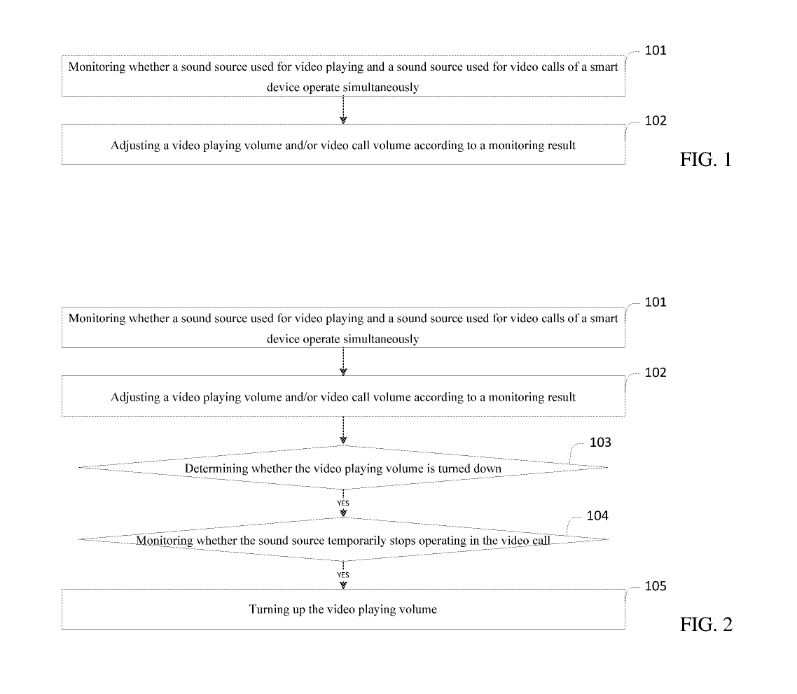

FIG. 1 shows a flow diagram of a method for automatically adjusting a volume under a picture by picture circumstance provided by this embodiment of the present disclosure. Referring to FIG. 1, the method includes the following steps:

Step 101: monitoring is performed on whether a sound source used for video playing and a sound source used for video calls of a smart device operate simultaneously.

In this step, the sound source used for video calls includes an input sound source and/or an output sound source, wherein the input sound source is used for receiving and playing an audio signal from the opposite party, while the output sound source is used for receiving an audio signal of a user and sending the audio signal to the opposite party. As long as one of the input sound source and the output sound source is operating, it is regarded that the sound source used for video calls is operating.

In practical application, whether the sound source used for video playing and the sound source used for video calls of the smart device operate simultaneously may be monitored in the following way: after detecting that the video call is connected and any one of the input sound source and the output sound source for the video call starts operating, checking whether the sound source used for video playing is used, and if yes, determining that the sound source used for video playing and the sound source used for video calls operate simultaneously.

Step 102, video playing volume and/or video call volume is/are adjusted according to a monitoring result.

In this step, the video playing volume and/or the video call volume is/are adjusted according to the monitoring result. For example, upon detecting that the sound source used for video playing and the sound source used for video calls operate simultaneously, the video call volume is turned up, or the video playing volume is turned down; or, based upon that the video playing volume is turned down, the video call volume is turned up. In this way, when the smart device plays a video program and is in a video call simultaneously, the volume of video playing or the video call can be automatically adjusted without manual adjustment. Therefore, the user's experience is enhanced.

According to the method for automatically adjusting a volume under a picture by picture circumstance as described in this embodiment, the operational states of the sound source used for video playing and the sound source used for video calls of the smart device are monitored in real time, and the video playing volume and/or the video call volume is/are adjusted automatically according to the monitoring result without manual intervention. Therefore, the user's experience is enhanced.

### Second Embodiment

In this embodiment of the present disclosure, provided is an implementation of the above step 102.

In this case, the above step 102 of adjusting the video playing volume and/or the video call volume according to the monitoring result includes:

turning up the video call volume upon detecting that the sound source used for video playing and the sound source used for video calls operate simultaneously.

In this embodiment, upon detecting that the sound source used for video playing and the sound source used for video calls operate simultaneously, the video call may be prevented from being influenced by the video being played by way of turning up the video call volume.

In this case, turning up the video call volume refers to simultaneously turning up the input volume and the output volume of the video call. After the video call volume is turned up, both parties of the video call can clearly hear the voice contents of the opposite parties. Therefore, the video call may go on normally without being influenced by the video being played.

### Third Embodiment

In this embodiment of the present disclosure, provided is another implementation of the above step 102.

In this case, the above step 102 of adjusting the video playing volume and/or the video call volume according to the monitoring result includes:

turning down the video playing volume upon detecting that the sound source used for video playing and the sound source used for video calls operate simultaneously.

In this embodiment, upon detecting that the sound source used for video playing and the sound source used for video calls operate simultaneously, the video call may be prevented from being influenced by the video being played by way of turning down the video playing volume.

In this case, turning down the video playing volume refers to turning down the output volume of video playing. After the video playing volume is turned down, both parties of the video call can clearly hear the voice contents of the opposite parties. Therefore, the video call can go on normally without being influenced by the video being played.

### Fourth Embodiment

In this embodiment of the present disclosure, provided is yet another implementation of the above step 102.

In this case, the above step 102 of adjusting the video playing volume and/or the video call volume according to the monitoring result includes:

turning down the video playing volume and turning up the video call volume upon detecting that the sound source used for video playing and the sound source used for video calls operate simultaneously.

In this embodiment, upon detecting that the sound source used for video playing and the sound source used for video calls operate simultaneously, the video call may be prevented from being influenced by the video being played by way of turning down the video playing volume and also turning up the video call volume.

In this case, turning down the video playing volume refers to turning down the output volume of video playing. Turning up the video call volume refers to simultaneously turning up the input volume and the output volume of the video call.

After the video playing volume is turned down and the video call volume is turned up, both parties of the video call can clearly hear the voice contents of the opposite parties. Therefore, the video call can go on normally without being influenced by the video being played.

The device embodiments described above are merely schematic, wherein the units illustrated as separate components may be physically separated or not; components displayed as units may be physical units or not, which can be located at the same place or distributed to a plurality of network units. Part or all of the units may be selected according to actual requirements to achieve the objects of the solutions of the embodiments. Those of ordinary skill in the art can understand and implement the solutions without creative work.

From the description of the above embodiments, those of ordinary skill in the art could clearly learn that the embodiments may be realized by means of software and a necessary general hardware platform, and of course, may also be realized by hardware. Based on such an understanding, the above technical solutions substantially or the part making contribution to the prior art may be embodied in the form of a software product, and the computer software product may be stored in a computer-readable storage medium, such as an ROM/RAM, a magnetic disk, an optical disk, or the like, which includes a plurality of instructions for enabling computer equipment (which may be a personal computer, a server, network equipment, or the like) to execute the method in the embodiments or some parts of the embodiments.

### Fifth Embodiment

In this embodiment of the present disclosure, based on the above third or fourth embodiment, the method for automatically adjusting a volume under a picture by picture circumstance also includes step 103, as shown in FIG. 2.

Step 103: a determination is made on whether the video playing volume is turned down; when the video playing volume is turned down, step 104 is executed.

Step 104: monitoring is performed on whether the sound source temporarily stops operating in the video call when the video playing volume is turned down; upon detecting that the sound source temporarily stops operating in the video call, step 105 is executed.

Step 105: the video playing volume is turned up.

In this embodiment, upon detecting that the sound source used for video playing and the sound source used for video calls operate simultaneously, the video call may be prevented from being influenced by the video being played by way of turning down the video playing volume. However, with proceeding of the video call, it is possible that both parties of the call temporarily stop the conversation; in this case, no audio input and no audio output exist in the video call for the smart device. That is, the sound source temporarily stops operating in the video call in this case; at this moment, the video playing volume may be automatically turned up, so that a user can watch the video program normally.

It thus can be seen that the method for automatically adjusting a volume under a picture by picture circumstance as described in this embodiment is capable of not only automatically turning down the video playing volume when the video call and video playing go on simultaneously, thereby ensuring that the video call goes on normally, but also automatically turning up the video playing volume when the sound source temporarily stops operating in the video call, thereby ensuring that the user watches the video program normally. Subsequently, if it is detected that both parties continue the conversation, the video playing volume can be turned down again to ensure that the video call goes on normally. Hence, the whole process does not require manual adjustment, and the user's experience is greatly enhanced.

The method for automatically adjusting a volume under a picture by picture circumstance as described in this embodiment is capable of satisfying a typical picture-by-picture (picture-in-picture) scenario where users chat for commenting while watching a football game, i.e., chatting while watching. For example, while watching a football game video, a user can make a video call to discuss the ball game situations (commenting). When the user has a chat to discuss goals, in order to ensure that the chat is not influenced by the football game video being played, the playing volume of the football game video can be automatically turned down; when the user stops the chat temporarily and wants to further watch the game, the playing volume of the football game video can be automatically turned up. Hence, the user's requirement of talking about the football game while watching is met. No manual adjustment is needed, and the user's experience is enhanced.

### Sixth Embodiment

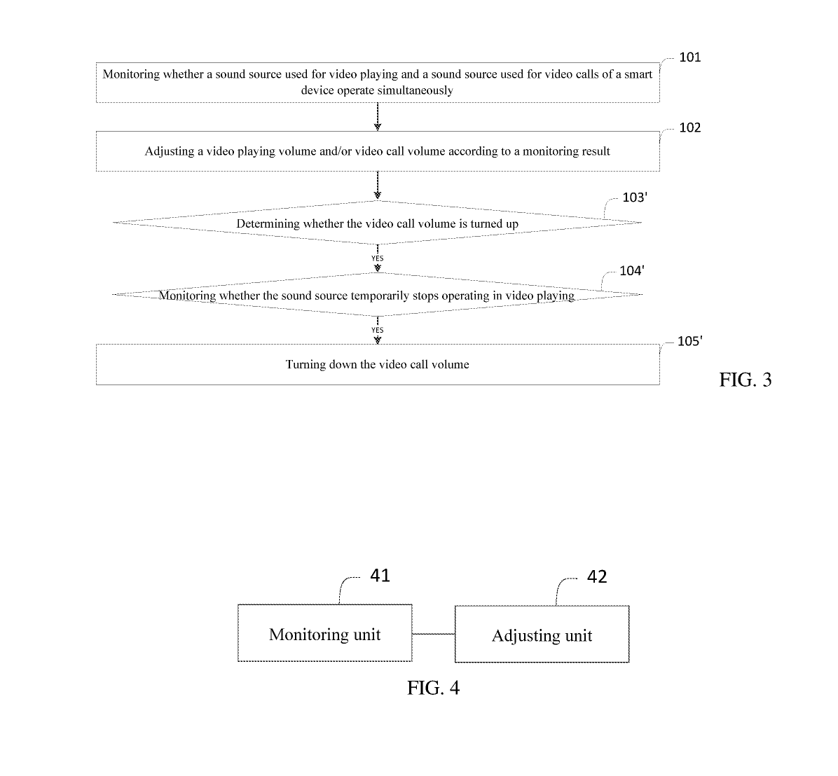

In this embodiment of the present disclosure, based on the above second or fourth embodiment, the method for automatically adjusting a volume under a picture by picture circumstance also includes step 103′, as shown in FIG. 3.

Step 103′: a determination is made on whether the video call volume is turned up; when the video call volume is turned up, step 104′ is executed.

Step 104′: monitoring is performed on whether the sound source temporarily stops operating in video playing; when the sound source temporarily stops operating in video playing, step 105′ is executed.

Step 105′: the video call volume is turned down.

In this embodiment, upon detecting that the sound source used for video playing and the sound source used for video calls operate simultaneously, the video call may be prevented from being influenced by the video being played by way of turning up the video call volume. However, if detecting that video playing is paused in this process (e.g., the user stops playing the video program in this process), which means that the sound source temporarily stops operating in video playing, in this case, the video call volume can be automatically turned down in order to avoid that the video call is too loud and makes the user feel uncomfortable.

It thus can be seen that the method for automatically adjusting a volume under a picture by picture circumstance as described in this embodiment is capable of not only automatically turning up the video call volume when the video call and video playing go on simultaneously, thereby ensuring that the video call goes on normally, but also automatically turning down the video call volume when the sound source temporarily stops operating in video playing, thereby ensuring that the user communicates with the opposite party at pleasant volume. Subsequently, if detecting that video playing is continued, the video call volume can be turned up again to ensure that the video call goes on normally; or the video playing volume is turned down to ensure that the video call goes on normally. Hence, the whole process does not require manual adjustment, and the user's experience is greatly enhanced.

### Seventh Embodiment

This embodiment of the present disclosure provides a device for automatically adjusting a volume under a picture by picture circumstance. Referring to FIG. 4, the device includes:

a monitoring unit 41 used for monitoring whether a sound source used for video playing and a sound source used for video calls of a smart device operate simultaneously, wherein the sound source used for video calls includes an input sound source and/or an output sound source; and

an adjusting unit 42 used for adjusting a video playing volume and/or video call volume according to a monitoring result of the monitoring unit.

The device for automatically adjusting a volume under a picture by picture circumstance as described in this embodiment is capable of monitoring the operational states of the sound source used for video playing and the sound source used for video calls of the smart device in real time, and automatically adjusting the video playing volume and/or the video call volume according to the monitoring result without manual intervention. Therefore, the user's experience is enhanced.

### Eighth Embodiment

In this embodiment of the present disclosure, the adjusting unit 42 is specifically used for:

turning up the video call volume when the monitoring unit detects that the sound source used for video playing and the sound source used for video calls operate simultaneously.

### Ninth Embodiment

In this embodiment of the present disclosure, the adjusting unit 42 is specifically used for:

turning down the video playing volume when the monitoring unit detects that the sound source used for video playing and the sound source used for video calls operate simultaneously.

### Tenth Embodiment

In this embodiment of the present disclosure, the adjusting unit 42 is specifically used for:

turning down the video playing volume and turning up the video call volume when the monitoring unit detects that the sound source used for video playing and the sound source used for video calls operate simultaneously.

### Eleventh Embodiment

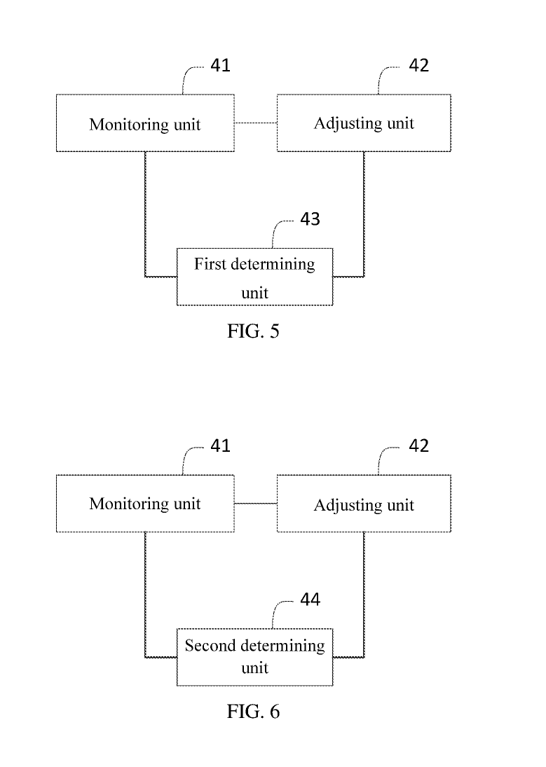

In this embodiment of the present disclosure, on the basis of the above ninth to tenth embodiments, the device also includes a first determining unit 43, as shown in FIG. 5;

the first determining unit 43 is used for determining whether the adjusting unit 42 turns down the video playing volume;

the monitoring unit 41 is also used for monitoring whether the sound source temporarily stops operating in the video call after the first determining unit 43 determines that the adjusting unit turns down the video playing volume;

accordingly, the adjusting unit 42 is also used for turning up the video playing volume when the monitoring unit 41 detects that the sound source temporarily stops operating in the video call.

### Twelfth Embodiment

In this embodiment of the present disclosure, on the basis of the above eighth to tenth embodiments, the device also includes a second determining unit 44, as shown in FIG. 6;

the second determining unit 44 is used for determining whether the adjusting unit 42 turns up the video call volume;

the monitoring unit 41 is also used for monitoring whether the sound source temporarily stops operating in video playing after the second determining unit 44 determines that the adjusting unit turns up the video call volume;

accordingly, the adjusting unit 42 is also used for turning down the video call volume when the monitoring unit 41 detects that the sound source temporarily stops operating in video playing.

The device as described in the seventh to twelfth embodiments of the present disclosure can be used for executing the method as described in the above first to sixth embodiments, and is similar to the method in principle and technical effects, which are not redundantly described herein.

### Thirteenth Embodiment

This embodiment of the present disclosure provides a smart device, including the device for automatically adjusting a volume under a picture by picture circumstance as described in any above embodiment.

The smart device described in this embodiment may be an intelligent electronic product such as a smart TV, a smart phone or a tablet computer. Since the smart device described in this embodiment includes the device for automatically adjusting a volume under a picture by picture circumstance as described in the above embodiments, the smart device is capable of achieving automatic volume adjustment for video playing and a video call; for example, the video playing volume is automatically turned down during the video call, thereby preventing the video call from being influenced by video playing. The smart device described in this embodiment does not need to be manually adjusted. Therefore, the user's experience is greatly enhanced.

### Fourteenth Embodiment

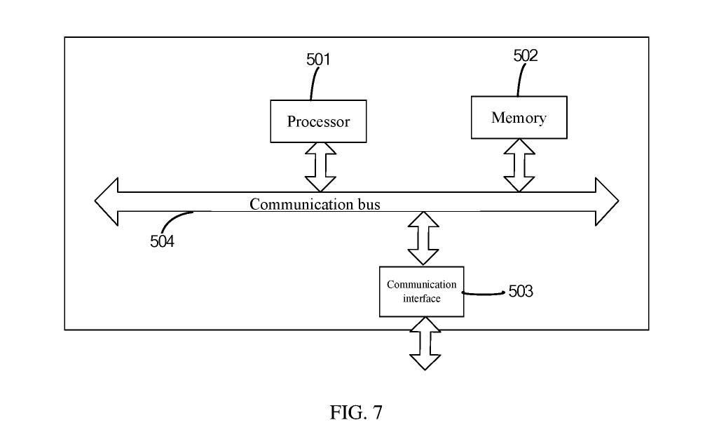

FIG. 7 shows a structural block diagram of a smart device provided by this embodiment of the present disclosure.

As shown in FIG. 7, the smart device provided by this embodiment of the present disclosure includes a processor 501, a memory 502, a communications interface 503 and a bus 504, wherein

the processor 501, the memory 502 and the communications interface 503 implement communications with each other by means of the bus 504;

the processor 501 is used for calling logical instructions in the memory to execute a method including:

monitoring whether a sound source used for video playing and a sound source used for video calls of a smart device operate simultaneously, wherein the sound source used for video calls includes an input sound source and/or an output sound source;

adjusting a video playing volume and/or video call volume according to a monitoring result.

FIG. 7 is schematic diagrams of a hardware structure of an electronic device for executing a processing method of list item operations provided by the embodiments of the disclosure. The device includes: one or more processors and a memory, with one processor as an example in FIG. 7.

The device for executing a processing method of list item operations provided by the embodiments of the disclosure may also include: an input device and an output device.

As a non-volatile computer-readable storage medium, the memory is available for storing non-volatile software programs, non-volatile computer-executable programs and modules, such as program instructions/modules corresponding to the processing method of list item operations in the embodiments of the present disclosure. By running non-volatile software programs, instructions and modules stored in the memory, the processor executes various function applications and data processing of a server, i.e., achieving the processing method of list item operations in the above method embodiments.

The memory may include a program storage region and a data storage region, wherein the program storage region is available for storing an operating system, and at least one functionally required application; the data storage region is available for storing data created according to the use of a processing device of list item operations, and the like. In addition, the memory may include a high-speed random access memory, and may also include a non-volatile memory, such as at least one magnetic disk storage device, a flash memory device, or other non-volatile solid-state storage devices. In some embodiments, the memory optionally includes memories remotely set with respect to the processor; these remote memories are connectable to the processing device of list item operations by means of networks. Examples of the networks include, but are not limited to, Internet, Intranet, LAN, mobile communication networks and combinations thereof.

The input device is capable of receiving input digit or character information, and producing key signal inputs related to user settings and function control of the processing device of list item operations. The output device may include a display device such as a display screen.

The one or more modules are stored in the memory, and execute the processing method of list item operations in any above method embodiment when executed by the one or more processors.

The products described above are capable of executing the method provided by the embodiments of the present disclosure, and has corresponding function modules for executing the method and beneficial effects. Those technical details not described in detail in the present embodiment may be found in the method provided by the embodiments of the present disclosure.

The electronic device provided by this embodiment of the present disclosure may be present in a plurality of forms, including but not limited to:
(1) Mobile communication equipment: such equipment is characterized by mobile communication functions and mainly intended to provide voice and data communications. Terminals of this type include: smart phones (e.g., iPhone), multimedia mobile phones, functional mobile phones, low-end mobile phones and so on.
(2) Ultra-mobile personal computer equipment: such equipment falls into the category of personal computers, has computing and processing functions, and generally also has a mobile network access characteristic. Terminals of this type include: PDA, MID, UMPC equipment, and the like, for example iPad.
(3) Portable entertainment equipment: such equipment is able to display and play multimedia contents, and includes: audio and video players (e.g., iPod), handheld game players, electronic book readers, and smart toys and portable vehicle-mounted navigation equipment.
(4) Servers: they are equipment providing computing service. Components of a server include a processor, a hard disk, a memory, a system bus and the like. The architecture of a server is similar to that of a general-purpose computer; however, since servers are required to provide highly reliable services, requirements in such aspects as processing ability, stability, reliability, safety, extendibility and manageability are relatively high.
(5) Other electronic devices having the function of data interaction.

### Fifteenth Embodiment

This embodiment of the present disclosure further discloses a computer program, including program codes used for executing the following operations:

monitoring whether a sound source used for video playing and a sound source used for video calls of a smart device operate simultaneously, wherein the sound source used for video calls includes an input sound source and/or an output sound source;

adjusting a video playing volume and/or video call volume according to a monitoring result.

### Sixteenth Embodiment

This embodiment of the present disclosure further discloses a storage medium used for storing the computer program as described in the above embodiment.

It can be understood by those of ordinary skill in the art that the implementation of all or part of the steps of the above method embodiments can be accomplished by means of program instruction related hardware. The aforementioned program can be stored in a computer-readable storage medium. When the program is executed, the steps in the above method embodiments are executed. The aforementioned storage medium includes various media capable of storing program codes, such as an ROM, an RAM, a magnetic disk, an optical disk, and the like.

Finally, it should be noted that the above embodiments are merely used for illustrating, rather than limiting, the technical solutions of the embodiments of the present disclosure. Although the embodiments of the present disclosure are described in detail with reference to the aforementioned embodiments, it should be understood by those of ordinary skill in the art that modifications may still be made to the technical solutions described in the aforementioned embodiments, or equivalent substitutions may be applied to part or all of the technical features therein; these modifications or substitutions do not cause the nature of the corresponding technical solutions to depart from the scope of the technical solutions of the embodiments of the present disclosure.

What is claimed is:

1. A method for automatically adjusting a volume under a picture by picture circumstance, performing the method at an electronic device, comprising:
monitoring whether a sound source used for video playing and a sound source used for video calls of a smart device operate simultaneously, wherein the sound source used for video calls comprises an input sound source and/or an output sound source;
adjusting a video playing volume and/or video call volume according to a monitoring result.

2. The method according to claim 1, wherein the step of adjusting the video playing volume and/or the video call volume according to the monitoring result comprises:
turning up the video call volume upon detecting that the sound source used for video playing and the sound source used for video calls operate simultaneously.

3. The method according to claim 1, wherein the step of adjusting the video playing volume and/or the video call volume according to the monitoring result comprises:
turning down the video playing volume upon detecting that the sound source used for video playing and the sound source used for video calls operate simultaneously.

4. The method according to claim 1, wherein the step of adjusting the video playing volume and/or the video call volume according to the monitoring result comprises:
turning down the video playing volume and turning up the video call volume upon detecting that the sound source used for video playing and the sound source used for video calls operate simultaneously.

5. The method according to claim 3, further comprising:
determining whether the video playing volume is turned down;
monitoring whether the sound source temporarily stops operating in the video call when the video playing volume is turned down;
turning up the video playing volume upon detecting that the sound source temporarily stops operating in the video call.

6. The method according to claim 2, further comprising:
determining whether the video call volume is turned up;
monitoring whether the sound source temporarily stops operating in video playing when the video call volume is turned up;
turning down the video call volume upon detecting that the sound source temporarily stops operating in video playing.

7. An electronic device, comprising:
at least one processor; and
a memory communicably connected with the at least one processor for storing instructions executable by the at least one processor, wherein execution of the instructions by the at least one processor causes the at least one processor to:
monitor whether a sound source used for video playing and a sound source used for video calls of a smart device operate simultaneously, wherein the sound source used for video calls comprises an input sound source and/or an output sound source;
adjust a video playing volume and/or video call volume according to a monitoring result.

8. The device according to claim 7, wherein the processor is further configured to perform the following steps:
turning up the video call volume when the sound source used for video playing and the sound source used for video calls operate simultaneously.

9. The device according to claim 7, wherein the processor is further configured to perform the following steps:
turning down the video playing volume when the sound source used for video playing and the sound source used for video calls operate simultaneously.

10. The device according to claim 7, wherein the processor is further configured to perform the following steps:
turning down the video playing volume and turning up the video call volume when the sound source used for video playing and the sound source used for video calls operate simultaneously.

11. The device according to claim 9, wherein the processor is further configured to perform the following steps:
determining whether the adjusting unit turns down the video playing volume;
monitoring whether the sound source temporarily stops operating in the video call after the adjusting unit turns down the video playing volume;
turning up the video playing volume when the sound source temporarily stops operating in the video call.

12. The device according to claim 8, wherein the processor is further configured to perform the following steps:
determining whether turns up the video call volume;
monitoring whether the sound source temporarily stops operating in video playing after determines that the adjusting unit turns up the video call volume;
turning down the video call volume when the sound source temporarily stops operating in video playing.

13. A non-transitory computer-readable storage medium storing executable instructions that, when executed by an electronic device with a touch-sensitive display, cause the electronic device to:
monitor whether a sound source used for video playing and a sound source used for video calls of a smart device operate simultaneously, wherein the sound source used for video calls comprises an input sound source and/or an output sound source;
adjust a video playing volume and/or video call volume according to a monitoring result.

14. The non-transitory computer-readable storage medium according to claim 13, wherein the electronic device is further configured to perform the following steps:
turning up the video call volume when the sound source used for video playing and the sound source used for video calls operate simultaneously.

15. The non-transitory computer-readable storage medium according to claim 13, wherein the electronic device is further configured to perform the following steps:
turning down the video playing volume when the sound source used for video playing and the sound source used for video calls operate simultaneously.

16. The non-transitory computer-readable storage medium according to claim 13, wherein the electronic device is further configured to perform the following steps:
turning down the video playing volume and turning up the video call volume when the sound source used for video playing and the sound source used for video calls operate simultaneously.

17. The non-transitory computer-readable storage medium according to claim 15, wherein the electronic device is further configured to perform the following steps:
determining whether the adjusting unit turns down the video playing volume;
monitoring whether the sound source temporarily stops operating in the video call after the adjusting unit turns down the video playing volume;
turning up the video playing volume when the sound source temporarily stops operating in the video call.

18. The non-transitory computer-readable storage medium according to claim 14, wherein the electronic device is further configured to perform the following steps:
determining whether turns up the video call volume;
monitoring whether the sound source temporarily stops operating in video playing after determines that the adjusting unit turns up the video call volume;
turning down the video call volume when the sound source temporarily stops operating in video playing.
